(19) United States
(12) Patent Application Publication
(10) Pub. No.: US 2026/0226366 A1
(43) Pub. Date: Aug. 6, 2026

(54) SYSTEMS AND TECHNIQUES FOR CONTROLLING FOULING SOLIDS WHEN EXTRACTING OLEAGINOUS MATERIAL USING AN ALCOHOL

(71) Applicant: Crown Iron Works Company LLC, Blaine, MN (US)

(72) Inventors: Nicholas Ollila, Fridley, MN (US); Wade Steven Martinson, Minneapolis, MN (US); Aaron Iwen, Mendota Heights, MN (US); Patrick Wayne Harrington, Minneapolis, MN (US); Ryan Popinga, Blaine, MN (US); Benjamin Wayne Floan, Andover, MN (US)

(21) Appl. No.: 19/529,932

(22) Filed: Feb. 4, 2026

Related U.S. Application Data
(60) Provisional application No. 63/753,675, filed on Feb. 4, 2025.

(51) Int. Cl. C11B 1/10; B01D 1/06; B01D 11/02; B01D 17/02; B01D 17/04

(52) U.S. Cl. CPC C11B 1/108; B01D 1/065; B01D 11/0288; B01D 17/0208; B01D 17/042; B01D 17/047; C11B 1/102

(57) ABSTRACT

Devices, systems, and techniques can be provided for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The resulting miscella formed by the extractor can be processed through multiple downstream processed steps to recover oil and solvent while reducing or eliminating processing challenges associated with fouling solids.

### CROSS-REFERENCE

This application claims the benefit of and priority to U.S. Provisional Patent Application No. 63/753,675, filed Feb. 4, 2025, the entire contents of which are incorporated herein by reference.

### TECHNICAL FIELD

This disclosure relates to solvent extraction and, more particularly to controlling liquid-solvent extraction using an alcohol-based solvent.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. As another example, extractors are used to recover oil from oil sands and other petroleum-rich materials. Typically, the petroleum-rich material is ground into small particles and then passed through an extractor to extract the oil from the solid material into a surrounding organic solvent.

During operation, the selected feedstock is passed through the extractor and contacted with a solvent. The solvent can extract oil out of the feedstock to produce an oil deficient solids discharge and a miscella stream. The miscella stream can contain the solvent used for extraction and oil extracted from the feedstock.

In practice, solvents such as hexane are typically used for extracting oil from oleaginous materials. The oil and/or extracted solid can be used as an intermediate or end product for human and/or animal consumption. While the solvent is removed from the oil and/or extracted solid prior to consumption, consumers are increasingly sensitive about food production processes and standards. Ethanol is alternative solvent to hexane that can be used to separate oil from various oleaginous materials. Ethanol is GRAS (Generally Recognized As Safe), can be produced organically, including from renewable feedstocks, and is already accepted by the consuming public as a component of alcoholic beverages.

### SUMMARY

In general, this disclosure is directed to devices, systems, and techniques, for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The alcohol-based solvent may travel in a countercurrent direction through the extractor from a direction of material travel that the feedstock travels through the extractor. In either case, a concentration of oil in the feedstock may decrease as the feedstock moves through the extractor from the inlet to the outlet. Similarly, the concentration of oil in the solvent may increase as the solvent moves through the extractor from the solvent inlet to the solvent outlet. The resulting liquid containing solvent and extracted oil discharging from the extractor, referred to as miscella, can be processed to separate the solvent from the extracted oil.

In practice, Applicant has observed processing problems associated with processing miscella generated by extracting an oleaginous material with an alcohol-based solvent to recover the extracted oil from the solvent. In some applications, foaming and/or fouling are observed when trying to recover the extracted oil from the solvent, which has the potential to limit the processing efficiency and commercial deployment of the technology. Without wishing to be bound by any particular theory, Applicant believes that phospholipids (e.g., gums) and/or other solids are extracted out of the oleaginous material with extraction of the oil fraction of the oleaginous feedstock material. In downstream processing, these phospholipids and/or other solids may have a tendency to accumulate and manifest both as a thick solid layer entraining oil and solvent (e.g., an intermediate layer separated from the solvent and oil fractions of the miscella) and/or as dissolved or colloidally dispersed species partially and/or fully dissolved in the solvent-rich phase, each of which can be challenging to process and can contribute to foaming, fouling, and deposition of solid foulants on and in processing equipment.

In accordance with some example of the present disclosure, systems and techniques are described for generating and processing a miscella stream generated by extracting an oleaginous feedstock with an alcohol-based solvent to reduce and/or eliminate processing problems and fouling that may be caused by extracted phospholipids and/or other extracted solids from the material being processed. In some examples, the miscella is sequentially processed through multiple separation steps to segregate a fraction of the miscella containing the solids from a remainer of the miscella, allowing the fraction of the miscella that can cause processing problems to be segregated and separately processed from a remainder of the miscella stream. In different applications, a solvent stream and/or an oil stream can be separated from a remainder of the miscella stream containing a solid phase that may cause processing problems. The solvent stream and/or oil stream can then be thermally processed to separate concentrated oil from solvent, with the solvent being reusable within the extraction process. The residual miscella stream containing the solid phase can then be processed through one or more gravity separation, mechanical separation, and/or thermal separation steps to selectively isolate the fouling solid phase from recoverable oil and/or solvent.

In some examples, an extraction system according to the disclosure can utilize an extractor to generate an oil-containing, solvent-containing, and solids-containing stream called the miscella and an oil-deficient solids stream carrying entrained solvent called a marc. To separate the oil from the solvent in the miscella stream, the miscella stream may be cooled to a temperature effective to cause phase separation between the polar solvent and the oil in the stream. For example, the miscella stream may be cooled to a temperature effective to cause the miscella to separate into a solvent-rich phase, an oil-rich phase, and a solid phase that includes entrained solvent and oil. The solvent-rich phase and the oil-rich phase can be separately treated for solvent recovery. Problematic solids can be treated by controlling downstream treatment of the solid phase and/or by controlling dissolved solids in the solvent-rich phase.

In some examples, a first separation may be performed on the cooled miscella to separate off a solvent-rich phase of sufficiently high purity to allow the separated solvent-rich phase to be recycled back to the extractor (e.g., with limited or no thermal processing before being recycled back). The remainder of the miscella stream can then be sent to a second separation for further processing. In the second separation, the remainder of the miscella stream may be processed to separate and recover a substantially pure oil-rich phase, leaving a second remainder of the miscella stream comprising a solid phase, and a remaining oil and/or solvent fraction (e.g., with either the oil or the solvent fraction being larger than the other in the second remainder).

In other examples, a first separation may be performed on the cooled miscella to separate off an oil-rich phase of sufficiently high purity that the separated oil-rich phase can be sent to thermal processing (e.g., to vaporize off a remaining portion of solvent), producing a concentrated oil stream. The remainder of the miscella stream can then be sent to a second separation for further processing. In the second separation, the remainder of the miscella stream may be processed to separate a solvent-rich phase, for example, of sufficiently high purity to allow the separated solvent-rich phase to be recycled back to the extractor (e.g., with limited or no thermal processing before being recycled back). This can leave a second remainder of the miscella stream comprising a solid phase, and a remaining oil and/or solvent fraction (e.g., with either the oil or the solvent fraction being larger than the other in the second remainder).

In any case, during separation, the solid phase containing entrained solvent and oil may be located between a lighter solvent-rich phase and a heavier oil-rich phase upon gravity settling. The cooled miscella stream may be supplied to a first separation device, such as a decanter, to remove a portion of the solvent-rich phase or a portion of the oil-rich phase from a remainder of the cooled miscella stream. As this separated portion of the solvent-rich phase or oil-rich phase may be substantially devoid of the fouling solid phase, it may be recycled or subsequently processed comparatively easily. In some instances, even after this initial separation, dissolved solids may remain in the solvent-rich phase, and the solvent-rich phase may be further processed to manage the partially or fully dissolved solids to reduce or eliminate downstream foaming and/or fouling problems.

In some examples, the remainder of the cooled miscella stream that includes the solids phase is supplied to a second separation device, such as a decanter, to remove another portion of the solvent-rich phase or oil-rich phase from a second remainder of the cooled miscella stream. Water may be added to the remainder of the cooled miscella stream between the first separation and second separation to promote additional phase separation between the solvent and oil in the stream, helping to drive efficient separation between the oil, solvent, and solids. In either case, the second separation can remove a solvent-rich stream or an oil-rich stream from the remainder of the cooled miscella stream, forming a second remainder of the cooled miscella stream that includes the solids phase. This second remainder can then be further processed.

In one example, a method is described that involves conveying an oleaginous material to be processed in a conveyance direction through an extractor and conveying a solvent comprising alcohol in a countercurrent direction from the conveyance direction through the extractor, thereby generating an extracted material stream and a miscella stream. The method also includes cooling the miscella stream to form a cooled miscella stream comprising a solvent-rich phase, an oil-rich phase, and a solid phase comprising entrained solvent and oil. The method involves performing a first separation on the cooled miscella stream to separate (i) the solvent-rich phase from a remainder of the cooled miscella stream comprising the oil-rich phase and the solid phase or (ii) the oil-rich phase from the remainder of the cooled miscella stream comprising the solvent-rich phase and the solid phase. The method further includes performing a second separation on the remainder of the cooled miscella stream to separate (i) the oil-rich phase from the solid phase comprising entrained solvent and oil or (ii) the solvent-rich phase from the solid phase comprising entrained solvent and oil.

In another example, a method is described that includes conveying an oleaginous material to be processed in a conveyance direction through an extractor and conveying a solvent comprising alcohol in a countercurrent direction from the conveyance direction through the extractor, thereby generating an extracted material stream and a miscella stream. The method involves cooling the miscella stream to form a cooled miscella stream and delivering the cooled miscella stream to a density separation device. The method includes, within the density separation device, separating the cooled miscella stream into a solvent-rich phase, an oil-rich phase, and a solid phase comprising entrained solvent and oil. The method also includes extracting three separate streams from the density separation device: a first stream of the solvent-rich phase, a second stream of the oil-rich phase, and a third stream of the solid phase comprising entrained solvent and oil.

In another example, a method is described that includes conveying an oleaginous material to be processed in a conveyance direction through an extractor and conveying a solvent comprising alcohol in a countercurrent direction from the conveyance direction through the extractor, thereby generating an extracted material stream and a miscella stream. The method includes cooling the miscella stream to form a cooled miscella stream comprising a solvent-rich phase, an oil-rich phase, and a solid phase comprising entrained solvent and oil. The method involves performing a first separation on the cooled miscella stream to separate a portion of the solvent-rich phase from a first remainder of the cooled miscella stream, the first remainder of the cooled miscella stream comprising the solid phase and performing a second separation on the first remainder of the cooled miscella stream to separate a portion of the oil-rich phase from a second remainder of the cooled miscella stream, the second remainder of the cooled miscella stream comprising the solid phase. The method further includes performing a first thermal separation on the second remainder of the cooled miscella stream including the solid phase to thermally separate solvent from the second remainder of the cooled miscella stream, thereby forming a first thermally separated residual stream comprising the solid phase. The method also includes performing a second thermal separation on the first thermally separated residual stream to thermally separate solvent from the first thermally separated residual stream, thereby forming a second thermally separated residual stream comprising the solid phase.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example extraction system with miscella separation processes according to the disclosure.

FIG. 2 is a block diagram illustrating an alternative configuration of an example extraction system with miscella separation processes according to the disclosure.

FIG. 3 is a block diagram illustrating another alternative configuration an example extraction system with miscella separation processes according to the disclosure.

FIG. 4A illustrates an example configuration of the extraction system of FIG. 1 configured with example downstream processing unit operations for further treating the miscella stream.

FIG. 4B illustrates another example configuration of the extraction system of FIG. 1 configured with example downstream processing unit operations for further treating the miscella stream.

FIG. 5 is an illustration of an example extractor configuration that can be used in the system of FIGS. 1-4.

### DETAILED DESCRIPTION

In general, the disclosure relates to liquid-solid extractor systems and processes that enable the extraction of one or more desired products from solid material flows. In some examples, the solid material is processed in a continuous flow extractor that conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet.

The solvent discharged from the extractor, which may be referred to as a miscella, contains extracted oil and other components, such as phosphorous-containing solids (e.g., phospholipids such as gums). These extracted solids can concentrate in the solvent phase of the miscella during subsequent processing of the miscella to separate the extracted oil and to recover the solvent for reuse, potentially resulting in foaming, fouling, and processing challenges. In accordance with some examples of the present disclosure, however, the miscella is sequentially processed through multiple separation steps to help maximize recovery of the extracted oil while segregating and separately treating a fraction of the miscella containing the problematic solids (e.g., which can include entrained solvent and/or oil).

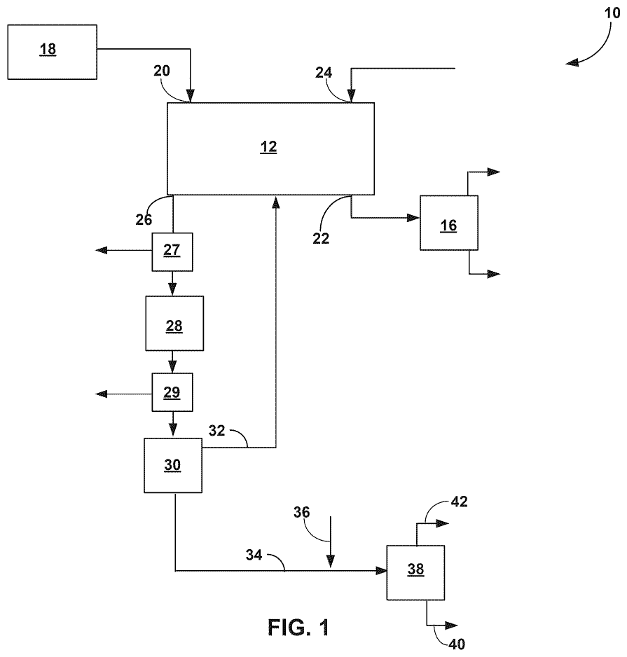

FIG. 1 is a block diagram illustrating an example extraction system 10 according to the disclosure. System 10 includes an extractor 12 and a desolventizer 16. System 10 is also illustrated as including a dryer 18 upstream of extractor 12. Extractor 12 has a feed inlet 20 that can receive a solid material after having undergone optional drying in dryer 18 to be subject to extraction within the extractor. Extractor 12 also has a feed outlet 22 that can discharge the solid particulate material after it has undergone extraction and has a lower concentration of extract than the fresh incoming material. Extractor 12 also has a solvent inlet 24 configured to introduce fresh solvent into the extractor and a solvent outlet 26 configured to discharge a miscella formed via extraction of extractable components from the solid material.

In operation, the solid material being processed is contacted with solvent within extractor 12 (e.g., in counter current fashion), causing components soluble within the solvent to be extracted from the solid material into the solvent. Extractor 12 can process any desired solid material using any suitable extraction fluid. Example types of solid material that can be processed using extractor 12 include, but are not limited to, plant-based materials containing gums including oleaginous matter, such as oil-bearing seeds and fruits like soybeans, rapeseed, sunflower seed, peanuts, cottonseed, palm kernels, and corn germ. The solid material being processed using extractor 12 can include phosphorous-containing compounds such as phospholipids (e.g., gums) that can extract into the solvent during extraction either in solid form or in solubilized form that subsequently precipitates into solid form. The resulting solid fraction in the miscella can entrain solvent and/or oil. Entrainment can occur when one substance (e.g., the solid fraction) interacts with and drags or carries along another intertwined substance (e.g., an amount of solvent and/or an amount of oil).

Alcohol-based solvents that can be used for extraction from solid material include, but are not limited to, mono-hydroxyl or multi-hydroxyl (e.g., di-hydroxyl) alcohols having carbon chains 1 to 8 carbons in length, such as 1 to 4 carbons in length, or 2 to 3 carbons in length. For example, the alcohol-based solvent may be ethanol or isopropyl alcohol. In some examples, the alcohol-based solvent consists essentially of alcohol (e.g., with or without water). For example, the alcohol-based solvent may be a hydrous alcohol or an anhydrous alcohol solvent. In some examples, the alcohol-based solvent has greater than 90 weight percent alcohol and less than 10 weight percent water, such as greater than 95 weight percent alcohol and less than 5 weight percent water, or greater than 97 weight percent alcohol and less than 3 weight percent water.

In some implementations, the incoming solid material to be extracted in extractor 12 is mechanically pressed to remove a portion of the oil from the solid material with the resulting pressed material forming the solid material for subsequent solvent extraction. Additionally or alternatively, the solid material to be solvent extracted may be dried by dryer 18 before being extracted in extractor 12. Dryer 18 can reduce the amount of water in the solid material supplied to extractor 12. When using an alcohol-based solvent, the water content of the solid material introduced into the extractor may be controlled to prevent excess water from entering the extractor, which can dilute the solvent (e.g., reducing the effectiveness of the extraction and/or making solvent recovery challenging). When used, dryer 18 may dry the solid material at a temperature greater than 30° C., such as greater than 50° C., or greater than 60° C., greater than 70° C., greater than 80° C., or greater than 100° C. Additionally or alternatively, dryer 18 may dry the solid material at a temperature less than 125° C., such as less than 100° C., or less than 80° C. For example, dryer 18 may dry the solid material at a temperature below the boiling point of water. In some examples, dryer 18 may dry the solid material at a temperature ranging from 40° C. to 90° C., such as from 50° C. to 80° C. Dryer 18 may typically operate at atmospheric pressure although, in other examples, may be configured to operate at a non-atmospheric pressure (e.g., vacuum pressure, positive pressure).

In still other examples, in addition to or in lieu of drying the solid material with dryer 18, the solid material may be pre-treated with a water removal solvent to remove water from the material prior to introducing the material into an extractor. In particular, the material to be processed can be contacted with a water removal solvent that causes water to transfer from the material into the water removal solvent. The water removal solvent having an increased concentration of water attributable to the water removed from the material can then be separated from the material to produce a solvent-wetted material having a reduced concentration of water. This solvent-wetted material can then be introduced into the extractor, typically while still solvent-wetted although optionally with intermediate drying, to subsequently extract oil from the feedstock in the extractor. The water removal solvent may or may not contain the same alcohol as the alcohol-based solvent subsequently used in the extractor to extract oil from the feedstock. Additional details on example pre-treatment using a water removal solvent are described in U.S. patent application Ser. No. 18/680,990, titled “ALCOHOL PRETREATMENT TO REMOVE WATER TO PREPARE OLEAGINOUS MATERIAL FOR SUBSEQUENT ALCOHOL-BASED SOLVENT EXTRACTION,” the entire contents of which is incorporated herein by reference.

Extractor 12 can produce a solvent-wet solids stream that discharges through feed outlet 22 and a miscella stream that discharges through solvent outlet 26. The miscella stream contains oil and solids extracted from the solid material processed in extractor 12. The miscella stream discharging from extractor 12 via miscella outlet 26 may be further processed separate the solvent from the oil and also to separate the extracted solids phase from the miscella, as discussed in greater detail below. To recover solvent from the solvent-wet solids stream and further prepare the residual extracted material for end use, the solvent-wet solids stream may be desolventized using mechanical and/or thermal desolventization devices. In the example of FIG. 1, system 10 includes a desolventizer 16. Desolventizer 16 can be implemented using one or more stages of mechanical and/or thermal treatment to remove solvent from the solvent-wet extracted solids stream, thereby producing a dried extracted solid material (which may also be referred to as a desolventized extracted solid material). It should be appreciated that reference to a dried and/or desolventized solid material refers to a material that is comparatively dried and desolventized and does not require complete drying or desolventization or that the material be devoid of solvent. Rather, the material may be dried and desolventized to a practical level effective for downstream use and/or processing.

In some examples, desolventizer 16 heats the extracted solid material (the solvent-wet solids stream) produced by extractor 12 to vaporize solvent from the stream to produce a dried solid material. While desolventizer 16 may inject steam into the extracted solid material in some implementations, in other implementations, desolventizer 16 may desolventize the extracted solid material without adding moisture to the material during desolventizing. For example, desolventizer 16 may directly and/or indirectly heat the extracted solid material without injecting steam into the extracted solid material. Desolventizer 16 may indirectly heat the extracted solid material by passing a heat transfer fluid through a tray that the extracted material contacts while passing through a desolventizing vessel and/or through a jacket surrounding at least a portion of the desolventizing vessel. Additionally or alternatively, desolventizer 16 may introduce a heated gas substantially devoid of moisture (e.g., dried air, nitrogen) into an interior of the desolventizing vessel and extracted solid material therein.

In different examples, desolventizer 16 can be implemented using a cooker, jacketed paddle mixer, bulk solids heat exchanger, and/or desolventizer-toaster. In any case, the solvent separated from the solvent-wet extracted solids stream via desolventizer 16 can be recycled back to extractor 12 for reuse (optionally with further processing, such as to decrease the water content in the solvent stream, before being returned to the extractor).

As noted above, extractor 12 produces a miscella stream that discharges through solvent outlet 26. This miscella stream can be further processed to help separate the oil fraction of the miscella stream from the solvent fraction extracted into the miscella. In the example of FIG. 1, system 10 includes a cooling unit 28 that is configured to receive the miscella stream and cool the stream to promote phase separation between the polar alcohol-based solvent component of the miscella and the extracted oil component of the miscella. Cooling unit 28 may be implemented using one or more heat exchangers or other thermal transfer devices that reduce a temperature of the miscella stream to a temperature effective to cause phase separation.

In practice, cooling the miscella stream can cause the miscella stream to separate into three phases (which may be mixed together in a fluid conduit but that can resolve into the three phases upon gravity settling): a solvent-rich phase, an oil-rich phase, and a solid phase that includes entrained solvent and entrained oil. Depending on the relative density of the solvent and extracted oil, the solvent-rich phase may be a light phase separates to the top of the miscella upon gravity settling, the oil-rich phase may be a heavy phase that separates to the bottom of the miscella upon gravity settling, and the solid phase may be an intermediate phase that separates between the solvent-rich phase and the oil-rich phase upon gravity settling. A compositional gradient may exist between the solvent-rich phase and the solids phase and also between the solids phase and the oil rich phase.

The relative amount of the solid phase in the miscella upon cooling may vary, e.g., depending on the composition of the feedstock being processed and the operating parameters of extractor 12. In some examples, however, the solid phase comprising entrained oil and solvent ranges from 1 wt % to 15 wt % of the overall cooled miscella stream, such as from 1 wt % to 5 wt %, or from 5 wt % to 10 wt %, or from 10 wt % to 15 wt %.

The solvent-rich phase may be composed primarily of solvent (with a remaining fraction being or including oil and/or solids). For example, the solvent-rich phase may be greater than 50 wt % solvent (where solvent comprises the alcohol and water components of the miscella), such as greater than 60 wt % solvent, greater than 70 wt % solvent, or greater than 80 wt % solvent. The solvent-rich phase can include partially or fully dissolved solids, such as phospholipids and other gum components, which remain in solution or as colloidal dispersions and are carried with the solvent-rich phase during downstream processing. The oil-rich phase may be composed primarily of extracted oil (with a remaining fraction being or including solvent and/or solids). For example, the oil-rich phase may be greater than 50 wt % oil, such as greater than 60 wt % oil, greater than 70 wt % oil, or greater than 80 wt % oil.

The temperature to which cooling unit 28 cools the miscella stream may be sufficiently low to promote phase separation between the oil-rich phase, solvent-rich phase, and solid phase. For example, cooling unit 28 may cool the miscella stream to a temperature less than 40 degrees Celsius, such as less than 30 degrees Celsius, or less than 20 degrees Celsius. While the miscella stream is generally described herein as being cooled (thereby providing a cooled miscella stream) before being processed downstream, it should be appreciated that some applications of the described systems and techniques may be implemented without pre-cooling the miscella stream. Accordingly, reference to a cooled miscella stream may be replaced with reference to just a miscella stream in these alternative applications.

In contrast to the temperature to which cooling unit 28 cools the miscella stream, the operating temperature of extractor 12 may be sufficiently hot to produce a miscella stream discharging from the extractor at a temperature greater than 50 degrees Celsius, such as greater than 60 degrees Celsius, or greater than 65 degrees Celsius. For example, the temperature of the miscella stream received from the extractor may range from 60 degrees Celsius to 90 degrees Celsius, such as from 65 degrees Celsius to 80 degrees Celsius, such as approximately 70 degrees Celsius.

Cooling the miscella stream can produce a solvent-rich phase separated from a solid-rich phase comprising entrained solvent and oil which, in turn, is separated from an oil-rich phase. A compositional gradient may exist between the solvent-rich phase, solid phase, and oil-rich phase formed by cooling the miscella stream. The solvent-rich phase may be referred to as a light phase, while the oil-rich phase may be referred to as a heavy phase.

The miscella stream discharged from extractor 12 may contain a variety of different solids, which may cause downstream fouling or other operational performance problems. Solids that may be included in the miscella stream include extractor solids, precipitated solids, and dissolved solids. Extractor solids can be solids, such as fine particles of the oleaginous material, that exist in the extractor miscella prior to chilling. Precipitated solids can be components, like a portion of the gums, that precipitate irreversibly upon cooling the extractor miscella by cooling unit 28. Dissolved solids can be components, like a portion of the gums, that precipitate only upon concentration by removing solvent from the miscella. The characteristics and amount of each type of solids present in the miscella may depend on various factors, such as the feedstock being processed, the composition of the solvent, and the characteristics of the extractor. The solids can be present in the solid phase and/or in the solvent-rich phase.

In some implementations, extraction system 10 may include a mechanical separator 27 (e.g., filter, centrifuge) that is configured to remove extractor solids from the miscella stream prior to cooling via cooling unit 28. Additionally or alternatively, extraction system 10 may include a mechanical separator 27 (e.g., filter, centrifuge) that is configured to remove precipitated solids (and, if not previously removed, extractor solids) from the miscella stream after cooling via cooling unit 28 but prior to further separation.

In either case, in the example of FIG. 1, extraction system 10 includes a first separator 30 to perform a first separation to separate solvent from the cooled miscella stream. First separator 30 may be implemented using a decanter (e.g., gravity decanter) and/or other liquid separation device, such as a centrifuge and/or cyclone. First separator 30 can separate a portion 32 of the solvent-rich phase from a first remainder of the cooled miscella stream 34. Accordingly, the first remainder of the cooled miscella stream 34 exiting first separator 30 can comprise the oil-rich phase, the solid phase, and a purged portion of the solvent-rich phase. In some examples, first separator 30 is operated to draw a substantially set amount of the solvent-rich phase stream 32 from the incoming cooled miscella stream (e.g., with the amount being set to ensure that substantially all or all of the solid phase is discharged with the oil-rich phase and is not drawn off with the solvent-rich phase steam 32). In some examples, the volume of the solvent-rich phase stream 32 discharging from first separator 30 divided by a total volume of the cooled miscella stream supplied to the first separator is within a range from 5% to 80%.

The solvent-rich phase stream 32 removed by first separator 30 can be recycled back to extractor 12. In different examples, solvent-rich phase stream 32 can be recycled to solvent inlet 24 of extractor 12 or to a location different than a location where fresh solvent is introduced into the extractor, which can be referred to as a second or recycle solvent inlet. For example, solvent-rich phase stream 32 may be recycled to extractor 12 and introduced into the extractor at an earlier extraction stage than an extraction stage where fresh solvent is introduced into the extractor. For example, solvent-rich phase stream 32 may be recycled back to extractor 12 and introduced into the extractor at a location where a composition of miscella in the extractor is substantially the same as a composition of the solvent-rich phase stream 32. For example, the concentration of the solvent in the solvent-rich phase stream 32 (e.g., calculated by dividing the weight of the alcohol and water by the combined weight of the alcohol, water, and oil) may be within ±20 weight percent of the concentration of the solvent in the miscella in the extraction stage of the extractor to which the separated solvent stream is recycled, such as within ±10 weight percent, or within ±5 weight percent.

The first remainder of the cooled miscella stream 34 exiting first separator 30 can be further processed to recover oil and/or to recapture solvent. In some examples, extraction system 10 is configured to introduce an amount of water 36 to the first remainder of the cooled miscella stream 34 to promote further phase separation between the oil component of the stream and the solvent component in the stream. The amount of water added to the first remainder of the cooled miscella stream 34 may be comparatively small, such as an amount of water that is less than 10 weight % of a weight of the first remainder of the cooled miscella stream, such as less than 5 weight %, less than 3 weight %, less than about 1 weight %, less than about 0.5 weight %, less than about 0.2 weight %, or less than about 0.1 weight %. In some examples, mixing equipment such as a static mixer, dynamic mixer, and/or homogenizer may be used to help intermix the water with the first remainder of the cooled miscella stream to facilitate mass transfer between the phases and promote further phase separation.

Adding an amount of water to the first remainder of the cooled miscella stream can cause further liquid-liquid phase separation between the oil component in the stream and the solvent component (e.g., alcohol) in the stream. This can form a second solvent-rich phase layer separated from the solid phase and the oil-rich phase. Again, a compositional gradient may exist between the second solvent-rich phase layer and the solid phase and the oil-rich phase formed by adding water to the first remainder of the cooled miscella stream 34.

Independent of whether water 36 is introduced into the first remainder of the cooled miscella stream 34, the first remainder of the cooled miscella stream is further processed in extraction system 10 of FIG. 1 to separate extracted oil from the remaining solvent purge portion and solids portion of the miscella. Extraction system 10 includes a second separator 38 that receives the first remainder of the cooled miscella stream 34 to perform a second separation to separate oil from the reminder of the cooled miscella stream. Second separator 38 may be implemented using a decanter (e.g., gravity decanter) and/or other liquid separation device, such as a centrifuge and/or cyclone. Second separator 38 can separate a portion 40 of the oil-rich phase from a second remainder of the cooled miscella stream 42. Accordingly, the second remainder of the cooled miscella stream 42 exiting second separator 38 can comprise a purge portion of the solvent-rich phase (not removed with stream 32 at first separator 30), the solid phase, and (where perfect separation is not achieved) a remaining portion of the oil-rich phase. The second remainder of the cooled miscella stream 42 can comprise a solvent-rich purge (e.g., excess solvent not returned to the extractor) and solids.

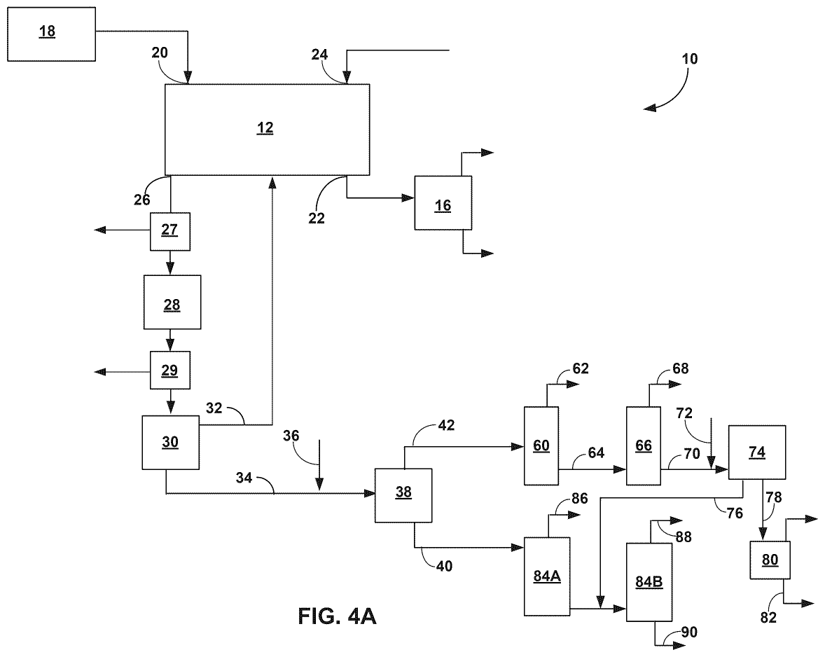

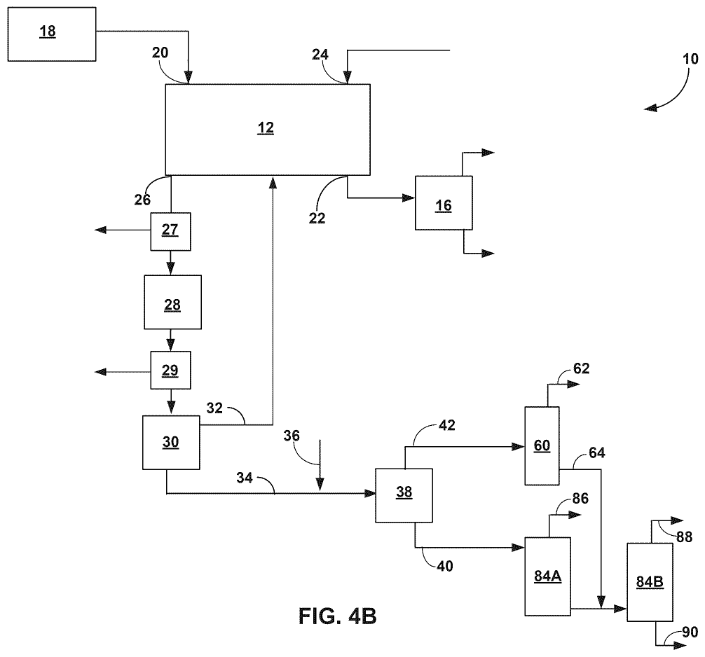

In some examples, second separator 38 is operated to draw a substantially set amount of the oil-rich phase stream 40 from the incoming first remainder of the cooled miscella stream (e.g., with the amount being set to ensure that substantially all or all of the solid phase is discharged with the solvent-rich phase and is not drawn off with the oil-rich phase steam 40). In some examples, the volume of the oil-rich phase stream 40 discharging from second separator 38 divided by a total volume of the first reminder of the cooled miscella stream supplied to the second separator is within a range from 5% to 75%. As described in greater detail below with respect to FIGS. 4A and 4B, the second remainder of the cooled miscella stream 42 can be further processed in various ways.

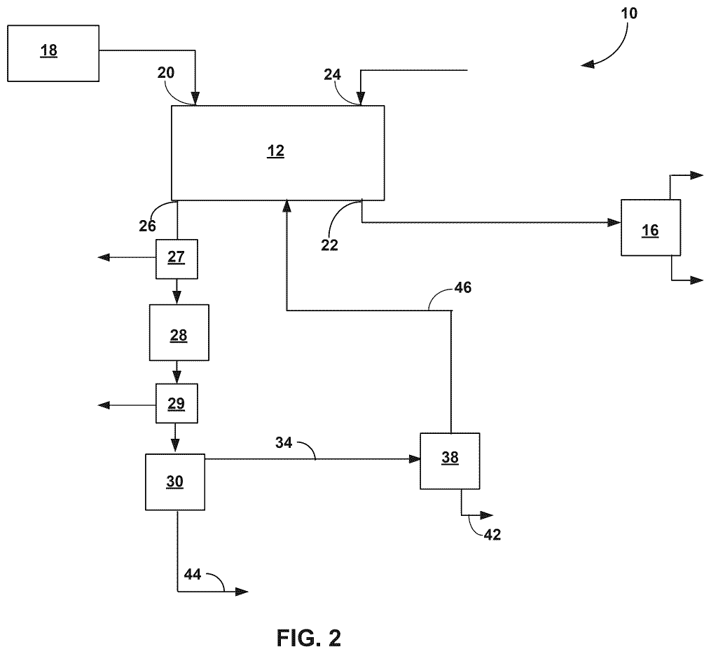

FIG. 2 is a block diagram illustrating an alternative configuration of extraction system 10 of FIG. 1 where like reference characters refer to like features discussed above with respect to FIG. 1. The configuration of extraction system 10 of FIG. 2 is similar to that of FIG. 1 except that the solids phase containing entrained solvent and oil is carried with the solvent-rich phase (e.g., light phase) out of first separator 30 rather than the oil-rich phase (e.g., heavy phase) as in FIG. 1. Further, the solids phase containing entrained solvent and oil is carried with a purge portion of the oil-rich phase (e.g., heavy phase) out of second separator 38 rather than a purge portion of the solvent-rich phase (e.g., light phase) as in FIG. 1.

In particular, in the example of FIG. 2, extraction system 10 includes previously-described first separator 30 that can separate a portion 44 of the oil-rich phase from a first remainder of the cooled miscella stream 34. Accordingly, the first remainder of the cooled miscella stream 34 exiting first separator 30 in this example can comprise the solvent-rich phase, the solid phase, and (where perfect separation is not achieved) a purge portion of the oil-rich phase. As with the example of FIG. 1, first separator 30 may be operated to draw a substantially set amount of the oil-rich phase stream 44 from the incoming cooled miscella stream (e.g., with the amount being set to ensure that substantially all or all of the solid phase is discharged with the solvent-rich phase and is not drawn off with the oil-rich phase steam 44). In some examples, the volume of the oil-rich phase stream 44 discharging from first separator 30 divided by a total volume of the cooled miscella stream supplied to the first separator is within a range from 10% to 15%.

The first remainder of the cooled miscella stream 34 discharging from first separator 30 in the example of FIG. 2 can be further processed to separate solvent from the first remainder of the cooled miscella stream. In some examples, second separator 38 can receive the first remainder of the cooled miscella stream 34 and perform a second separation to separate solvent from the reminder of the cooled miscella stream.

Second separator 38 can separate a portion 46 of the solvent-rich phase from a second remainder of the cooled miscella stream 42. Accordingly, the second remainder of the cooled miscella stream 42 exiting second separator 38 can comprise a purge portion of the oil-rich phase (not removed with stream 44 at first separator 30), the solid phase, and (where perfect separation is not achieved) a remaining portion of the solvent-rich phase. The solvent-rich phase stream 46 removed by second separator 38 can be recycled back to extractor 12, as discussed above with respect to solvent-rich phase stream 32 in connection with FIG. 1.

In some examples, second separator 38 is operated to draw a substantially set amount of the solvent-rich phase stream 46 from the incoming first remainder of the cooled miscella stream (e.g., with the amount being set to ensure that substantially all or all of the solid phase is discharged with the oil-rich phase and is not drawn off with the solvent-rich phase steam 46). In some examples, the volume of the solvent-rich phase stream 46 discharging from second separator 38 divided by a total volume of the first reminder of the cooled miscella stream supplied to the second separator is within a range from 5% to 85%. The second remainder of the cooled miscella stream 42 can be further processed in various ways, as discussed herein.

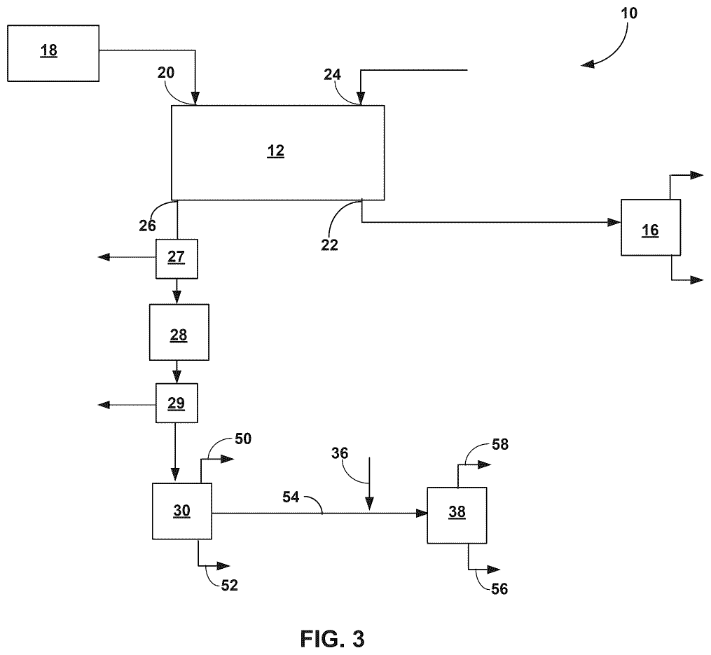

FIG. 3 is a block diagram illustrating another alternative configuration of extraction system 10 of FIG. 1 where like reference characters refer to like features discussed above with respect to FIG. 1. In the configuration of FIG. 3, the cooled miscella stream is delivered to first separator 30 which, in this example, is illustrated as a density separation device having three draw streams.

Example density separation devices that can be used as separator 30 in the example of FIG. 3 include gravity separation vessels and centrifuges configured to resolve a cooled miscella into solvent-rich, oil-rich, and solids-containing phases. In some implementations, a gravity separation vessel, such as a decanter, provides quiescent settling in an elongated, baffled chamber sized to promote residence time sufficient for density-driven stratification of a light solvent-rich phase, an intermediate solids-laden phase, and a heavy oil-rich phase. The decanter may incorporate adjustable draw-off weirs, interface level controls, and temperature conditioning to maintain viscosity and interfacial tension conducive to sharp phase boundaries. In other implementations, a centrifuge can be employed to accelerate phase separation under high g-forces, thereby reducing footprint and residence time and improving separation of finely dispersed solids. For example, a three-phase centrifuge, such as a Flottweg Tricanter, can continuously discharge a solvent-rich phase and an oil-rich phase while conveying a dewatered or de-oiled solids phase via an internal scroll, with bowl speed, differential speed, pond depth, and feed conditioning being selected to control cut points and minimize carryover. Either device may be operated singly or in combination, for instance by using a decanter for bulk split followed by a three-phase centrifuge for polishing, or vice versa, with selection guided by feed composition, solids particle size distribution, solvent-to-oil ratio, target purities, fouling propensity, and overall energy and maintenance considerations.

Independent of the configuration of separator 30 in the example of FIG. 3, the cooled miscella can separate into (1) a solvent-rich phase, which may be a light phase that separates to the top of the miscella upon gravity settling, (2) an oil-rich phase, which may be a heavy phase that separates to the bottom of the miscella upon gravity settling, and (3) a solid phase, which may be an intermediate phase that separates between the solvent-rich phase and the oil-rich phase upon gravity settling. Separator 30 can be configured with a first discharge configured to discharge a first stream 50 of the solvent-rich phase, a discharge configured to discharge a second stream 52 of the oil-rich phase, and a third discharge configured to discharge a third stream 54 that is a liquid volume comprising the solid phase entrained solvent and oil. The third discharge can be located between the first and second discharge locations of separator 30. The volume of liquid removed through the third discharge may be sufficiently large such that substantially all of the solid phase is withdrawn through the third discharge (e.g., along with excess solvent and/or oil carried with the solid phase).

In the configuration of FIG. 3, a portion of first stream 50 of the solvent-rich phase can be recycled to extractor 12 to serve as a process solvent, for example introduced at a recycle solvent inlet positioned upstream of the fresh solvent addition to maintain countercurrent efficiency and compositional matching within ±20 weight percent of the in-situ miscella at the selected stage. A remaining portion of first stream 50 can be directed to thermal separation devices (e.g., one or more evaporators) for solvent recovery in parallel or series with stream 58, allowing coordinated thermal processing of both the solvent-rich phase and the additional solvent-bearing stream to balance heat duty, manage solids loading, and optimize overall solvent reclamation. In such arrangements, flow splits between recycle and evaporation can be controlled in response to real-time solvent purity, water content, and dissolved solids concentration, with evaporator operating conditions (e.g., pressure, temperature, and recirculation rate) adjusted to minimize fouling while achieving target solvent removal prior to condensation and reuse in the extraction circuit.

The third stream 54 comprising the solid phase discharging from first separator 30 in the example of FIG. 3 can be further processed to separate residual oil and solvent. In some examples, water 36 is introduced into the third stream 54, and optionally mixed, to promote separation of extracted oil and solvent in the miscella, as discussed above with respect to FIG. 1. In some examples, the resulting stream is further cooled (e.g., using a second cooling unit as discussed above with respect to cooling unit 28) to help promote phase separation. In either case, the stream can be supplied to a second separator 38.

Second separator 38 can separate a portion 56 of the oil-rich phase from a remainder of the third stream 54. Accordingly, the remainder of the third stream 54 exiting second separator 38 can comprise a portion of the solvent-rich phase (not removed with first stream 50 at first separator 30), the solid phase, and (where perfect separation is not achieved) a remaining portion of the oil-rich phase.

Any of the downstream processing discussed in greater detail below with respect to FIGS. 4A and 4B can be performed on first stream 50, second stream 52, and/or third stream 54.

As briefly discussed above, the portion of the miscella stream containing the solid phase after performing one or more separations to remove a portion of the solvent-rich phase and/or a portion of the oil-rich phase can be further treated in a variety of different ways. FIG. 4A illustrates an example configuration of extraction system 10 configured with example downstream processing unit operations for further treating the remaining portion of the miscella stream containing the solid phase to recover additional oil, solvent, and/or solids. Like reference characters in FIG. 4A refer to like features discussed above with respect to FIG. 1. The example techniques and processing steps described with respect to FIG. 4A can be performed on any miscella stream containing a solid phase as described herein (e.g., second cooled miscella stream 42 generated according to the examples of FIG. 1 or 2, or third stream 54 before or after processing through second separator 38 according to the example of FIG. 3, and/or solvent-rich phase stream containing partially or fully dissolved solids). For purposes of illustration and discussion, however, the example of FIG. 4A shows and arrangement of processing steps according to the configuration of FIG. 1 to provide a second remainder of the cooled miscella stream 42 for further processing.

In the example of FIG. 4A, extraction system 10 is configured to process the second cooled miscella stream 42 generated by second separator 38 by performing a first thermal separation on the second remainder of the cooled miscella stream using a first thermal separation device 60. First thermal separation device 60 can receive some or all of the second cooled miscella stream 42 and vaporize solvent 62 (e.g., a portion of the solvent-rich phase) from the stream via application of thermal energy. First thermal separator 60 may be implemented using a stripping column (e.g., that utilizes steam or other motive gas), a distillation column, an evaporator, and/or other thermal separation device. In some applications, first thermal separation device 60 is implemented using an evaporator, such as a falling film evaporator, a forced recirculation evaporator, and/or a rising film evaporator. Additionally or alternatively, first thermal separation device 60 may be implemented as an evaporator system comprising multiple evaporators arranged in series, for example as a staged or multiple-effect train configured to progressively concentrate the liquid while managing heat duty and fouling propensity. In such configurations, successive evaporators may operate at decreasing pressures and temperatures to achieve incremental solvent removal with interstage surge volumes, recirculation loops, or flash drums that accommodate viscosity increase and permit optional removal of precipitated solids between stages. The evaporator system can be controlled to concentrate the miscella up to a target solids concentration threshold selected to balance solvent recovery efficiency against viscosity and fouling limits, after which the concentrated stream is passed downstream. In either case, first thermal separation device 60 can vaporize solvent 62 from the second remainder of the cooled miscella stream (which can be condensed and recovered), with the residual portion of the stream forming a first thermally separated residual stream 64 that includes the solid phase with entrained oil and solvent carried into the separation device.

Downstream of first thermal separation device 60, extraction system 10 can be configured to process the first thermally separated residual stream 64 by performing a second thermal separation on the first thermally separated residual stream using a second thermal separation device 66. Second thermal separation device 66 can receive some or all of the first thermally separated residual stream 64 and further vaporize solvent 68 (e.g., a portion of the solvent-rich phase) from the stream via application thermal energy. Because the solid phase is at an increased concentration relative to first thermally separated residual stream 64 at this stage of the process, there is a tendency for fouling to occurring in second thermal separation device 66. Accordingly, second thermal separation device 66 may be implemented using a fouling-resistant thermal separation device, such as a fouling-resistant evaporator. Example fouling-resistant thermal separation devices that can be used as second thermal separation device 66 include a forced recirculation evaporator and/or a wiped film evaporator. In either case, second thermal separation device 66 can vaporize solvent 68 from the first thermally separated residual stream 64 (which can be condensed and recovered), with the residual portion of the stream forming a second thermally separated residual stream 70 that includes the solid phase.

Downstream of first thermal separation device 60, extraction system 10 can be configured to process the first thermally separated residual stream 64 by performing a second thermal separation on the first thermally separated residual stream using a second thermal separation device 66. Second thermal separation device 66 can receive some or all of the first thermally separated residual stream 64 and further vaporize solvent 68 (e.g., a portion of the solvent-rich phase) from the stream via application of thermal energy. Because the solid phase is at an increased concentration relative to first thermally separated residual stream 64 at this stage of the process, there is a tendency for fouling to occur in second thermal separation device 66. Accordingly, second thermal separation device 66 may be implemented using a fouling-resistant thermal separation device, such as a fouling-resistant evaporator. Example fouling-resistant thermal separation devices that can be used as second thermal separation device 66 include a forced recirculation evaporator and/or a wiped film evaporator. In some applications, second thermal separation device 66 is additionally or alternatively implemented as a stripping column equipped with sparge steam, operated to introduce a controlled flow of steam through the liquid to provide a stripping vapor that lowers the partial pressure of the solvent, enhances mass transfer, and removes trace solvent. The addition of sparge steam can facilitate evaporation of residual solvent to very low levels while suppressing foam formation in streams containing elevated concentrations of solids and gums, for example by promoting gentle disengagement and minimizing surface accumulation that otherwise contributes to stable foam. The stripping column may be operated at atmospheric pressure or under vacuum, with steam rate, column residence time, and temperature selected to balance solvent removal efficiency against fouling propensity and thermal exposure of the oil and solids. In any of these configurations, second thermal separation device 66 can vaporize solvent 68 from the first thermally separated residual stream 64 (which can be condensed and recovered), with the residual portion of the stream forming a second thermally separated residual stream 70 that includes the solid phase.

In one implementation, the second remainder of the cooled miscella stream 42 is processed in the first thermal separation device 60 to reduce solvent content to approximately 20 wt % solvent, for example within a range of about 25 wt % to about 15 wt %, such as about 30 wt % to about 10 wt % depending on feed composition, residence time, and operating pressure. The resulting first thermally separated residual stream 64 can then be processed in the second thermal separation device 66 to further reduce solvent content of second thermally separated residual stream 70 to approximately 1 wt %, for example within a range of about 2 wt % to about 0.5 wt %, such as about 3 wt % to about 0.1 wt %, with the achievable endpoint governed by equipment selection (e.g., fouling-resistant evaporator or stripping column with sparge steam), vacuum level, and foam management. These staged reductions enable robust solvent recovery while controlling viscosity and fouling propensity in first thermal separation device 60 and achieving near-trace solvent levels in second thermal separation device 66 suitable for downstream handling, degumming, and oil polishing.

The volume of second thermally separated residual stream 70 may be sufficiently small that no further processing is performed on the stream, e.g., and the stream is discarded or otherwise discharged from extraction system 10. In other examples, second thermally separated residual stream 70 may be further processed to recover valuable constituent components and/or further separate components for downstream discharge.

In some applications, second thermally separated residual stream 70 is processed to water degum the stream and to separate solid gums from residual miscella liquid (e.g., solvent). As shown in the example of FIG. 4A, an amount of water 72 can be introduced into second thermally separated residual stream 70 to promote separation of the solids (e.g., gums) in the stream from residual oil and/or solvent fractions. The amount of water added to second thermally separated residual stream 70 may vary and, in some examples, is less than 20 weight % of a weight of second thermally separated residual stream 70, such as less than 10 weight %, less than 5 weight %, less than about 3 weight %, or less than 1 weight %. In some examples, mixing equipment may be used to help intermix the water with the stream.

Extraction system 10 can include one or more unit operations 74 to degum and separate solid gums from residual solvent and/or oil fractions. Example unit operations 74 can include mixing equipment such as a static mixer, dynamic mixer, and/or homogenizer that may be used to help intermix the water, followed by a reactor (e.g., an agitated reactor) for hydration of the gums (e.g., with a residence time from 15 min to 1 hour, such as approximately 30 min), and then phase separation by centrifuge. This can produce a residual liquid stream 76 (comprising solvent and/or oil) and a liquid-wetted solids stream 78. The solids stream 78 can be dried in a dryer 80 to recover dried gums 82, which may be further purified and sold as lecithin, a high-value food ingredient. Dryer 80 may be implemented as an evaporator (e.g., thin film evaporator) or other suitable dryer.

As briefly noted above, the portion 40 of the oil-rich phase separated from the miscella stream (e.g., from the incoming cooled miscella stream to also form a second remainder of the cooled miscella stream 42), can be further processed. In the example of FIG. 4A, extraction system 10 includes at least one thermal separator 84 (which can be referred to a third thermal separator 84 when implemented in a system that includes first thermal separator 60 and second thermal separator 66). Thermal separator 84 can be implemented in one or more stages and/or unit operations that can receive some or all of oil-rich phase 40 to remove residual solvent from the stream. Thermal separator 84 can be implemented using a stripping column (e.g., that utilizes steam or other motive gas), a distillation column, an evaporator, and/or other thermal separation device.

In some examples, thermal separator 84 is implemented using an evaporator and/or stripping column. For example, the portion 40 of the oil-rich phase being processed to remove solvent may be heated in an evaporator 84A to vaporize and remove a first portion of solvent 86 with the remaining oil then being stripped in a stripping column 84B to remove some or all of the residual solvent 88 from the oil, producing a concentrated oil 90. As shown in the example of FIG. 4A, residual liquid stream 76 (comprising solvent and/or oil) can be introduced with the stream supplied to stripping column 84B to strip solvent from the liquid, allowing residual oil in the stream to also be recovered. In other examples, residual liquid stream 76 may be separately processed.

FIG. 4B illustrates another example configuration of extraction system 10 configured with example downstream processing unit operations for further treating the remaining portion of the miscella stream containing the solid phase to recover additional oil, solvent, and/or solids. Like reference characters in FIG. 4B refer to like features discussed above with respect to FIGS. 1 and 4A. The example techniques and processing steps described with respect to FIG. 4B can be performed on any miscella stream containing a solid phase as described above with respect to FIG. 4A.

In the configuration illustrated in FIG. 4B, the first thermal separation device 60 generates the first thermally separated residual stream 64, which is directed to the inlet of the stripping column 84B either independently of or in combination with the discharge from the evaporator 84A. In some examples, the first thermally separated residual stream 64 is routed directly to the stripping column 84B as a dedicated feed that bypasses the evaporator 84A, allowing the stripping column 84B to remove residual solvent from a solids-rich, more viscous stream while the evaporator 84A concurrently treats the oil-rich phase portion 40 in a separate path. This arrangement can reduce fouling risk in the evaporator 84A by keeping higher solids loading out of the evaporator and can simplify temperature and residence time control in the stripping column 84B, which may be equipped with sparge steam to drive trace solvent removal at mild bulk temperatures. The direct-feed mode can be selected when the composition of the first thermally separated residual stream 64 exhibits elevated gums or precipitated solids, when the evaporator 84A is capacity-limited, or when foam propensity indicates a need for more gentle vapor- liquid disengagement in the stripping column 84B.

In other examples, the first thermally separated residual stream 64 is combined with the discharge of the evaporator 84A upstream of the inlet to the stripping column 84B so that both streams enter the stripping column as a blended feed. This configuration can provide heat integration and improve stripping efficiency by delivering a higher, more uniform inlet temperature and a consolidated solvent partial pressure profile across the stripping column 84B. The flow split between bypass and combination can be dynamically controlled based on measured solvent content, viscosity, solids loading, and foam tendency, with control valves and a common manifold enabling seamless transition between direct and combined operation. In either case, the stripping column 84B can be operated to accommodate variable feed rates and compositions, for example by adjusting steam rate, column pressure, and internal residence time to achieve target residual solvent levels while managing fouling and thermal exposure.

When implemented according to FIG. 4B, thermal separation device 60 can be configured as any one or more stages of thermal separation, including individual units or combinations of features described for the first thermal separation device 60 and the second thermal separation device 66. For example, thermal separation device 60 in FIG. 4B may comprise a single evaporator (e.g., falling film, rising film, or forced recirculation), a multiple-effect evaporator system arranged in series to progressively concentrate the miscella to a target solids threshold, a distillation column, and/or a stripping column with sparge steam operated to lower solvent partial pressure and suppress foam. In some implementations, thermal separation device 60 in FIG. 4B can be a hybrid train that integrates evaporators with interstage surge volumes or flash drums for viscosity management and optional solids removal, followed by a stripping column under atmospheric or vacuum conditions to achieve near-trace residual solvent. Selection and sequencing of stages, operating pressures and temperatures, and recirculation rates can be tailored to feed composition, dissolved and precipitated solids loading, and foam propensity to balance solvent recovery efficiency against fouling risk and thermal exposure, with the resulting thermally separated residual stream 64 directed to the stripping column 84B either independently or blended with the discharge of the evaporator 84A.

Extractor 12 in any of the foregoing examples can be implemented using any suitable type of extractor configuration. For example, extractor 12 may be an immersion extractor, a percolation extractor, or yet other type of extractor design. In one example, extractor 12 is a shallow bed continuous loop extractor.

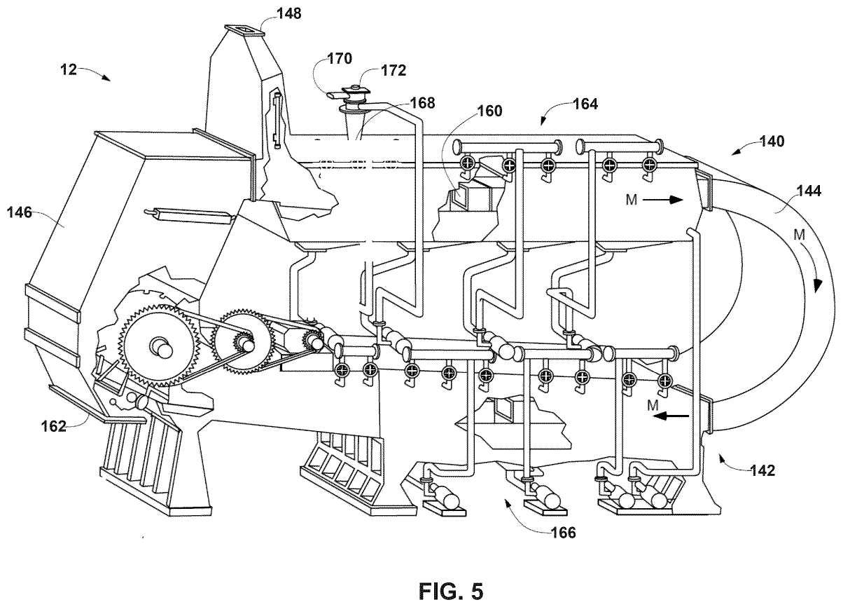

FIG. 5 is an illustration of an example extractor configuration that can be used for extractor 12. In the example shown, extractor 12 includes a housing defining a passageway in the form of a loop disposed in a vertical plane. The extractor can include upper and lower extraction sections 140, 142 each with a series of extraction chambers, a generally arcuate hollow transfer section 144 having its opposite upper and lower ends connected to first ends of the upper and lower extraction sections respectively, and a hollow, generally vertical return section 146 connected at its upper and lower ends respectively to the other ends of the upper and lower extraction sections. The upper extraction section can include an inlet portion 148 for delivery of solid material to the interior thereof in closely spaced relation to the upper end of the return section, and the lower end of the return section can define an opening 162 for discharge of the material after the product-of-interest has been extracted therefrom. The number of extraction chambers, or stages, provided by the extractor can vary depending on the desired sized of the extractor. The extractor includes at least one extraction chamber, or stage, and typically includes multiple stages (e.g., 6 stages, 8 stages, or more). A Model III extractor commercially available from Crown Iron Works Company of Minneapolis, MN, is a specific example of an extractor of this type.

In such an extractor, a conveyor system 160 can extend longitudinally through the looped passageway and be driven in a material flow direction “M” to move the material as a bed from the inlet portion 148 through the upper extraction section 140 toward and downwardly through the transfer section 144, and through the lower extraction section 142 toward the lower end of the return section and the discharge opening 162. In some embodiments, the conveyor system includes a pair of laterally spaced endless link chains and a plurality of longitudinally spaced flights that extend transversely of the chains. A motor and gearing may be provided to drive the conveyor.

In some configurations, a fluid supply system 164 can be disposed above the solid materials and configured to apply a fluid to the solid materials in each extraction chamber, and a fluid removal system 166 can be disposed below the solid materials and configured for removing the fluid after it has passed through the solid materials in each extraction chamber. In some embodiments, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed solid material, allowing the extraction fluid to then percolate through the material. The fluid removal system may include a network of drains, pumps, and pipes to collect the fluid after it has percolated through the solid material in each extraction chamber and deliver it to the fluid supply system of another extraction chamber or remove it from the system.

As shown in FIG. 5, fluid having passed through the solid material is collected by the fluid removal system 166 and delivered to a separation device 168, which in the illustrated example is shown as a cyclone-type separator to separate any solid fines from the fluid before fluid discharge. An outlet conduit 170 of separation device 168 can deliver the fluid, generally a mixture of extraction fluid and soluble components extracted from the solid material into the extraction fluid (e.g., oil when processing oil seed) (commonly known as “miscella”), to other equipment, not shown, for separating the extraction fluid from the material extracted from the solid material being processed. A separate outlet 172 of separation device 168 can deliver a stream containing particulate matter separated from the miscella for further processing.

As material is conveyed through extractor 12, spray headers from the fluid supply system 164 spray recycled extraction fluid on the top of the material. The material percolates through the material and through the screen, where it is collected in the network of drain pipes and delivered back to the network of spray headers where it is reapplied to the solid material in a different extraction chamber. In some embodiments, fresh extraction fluid is applied to the material in the last extraction chamber before the solid material discharge 162. For example, fresh extraction fluid may be applied to the material in the last extraction chamber before discharge 162 and, after being collected at the bottom of the chamber, recycled and applied on top of solid material in an adjacent upstream extraction chamber. By recycling collected extraction fluid from one extraction chamber to an adjacent upstream extraction chamber, liquid extraction fluid and solid material being processed can move in countercurrent directions through the extractor. For example, as extraction fluid is conveyed sequentially through adjacent extraction chambers between a fresh extraction fluid inlet adjacent discharge 162 and an enriched extraction fluid outlet adjacent inlet 148, the concentration of extract relative to extraction fluid increases from a relatively small extract-to-extraction fluid ratio to a comparatively large extract-to-extraction fluid ratio. Similarly, as the solid material is conveyed in the opposing direction, the concentration of extract in the solid feedstock decreases from a comparatively high concentration at the inlet 148 to a comparatively low concentration at the outlet 162.

An alcohol-based solvent extraction process according to the present disclosure may provide various advantages over an extraction process that does not use an alcohol-based solvent. For example, an alcohol-based solvent may provide better compatibility with food supply chains. Ethanol is GRAS (Generally Recognized As Safe), can be produced organically from renewable feedstocks, and is already consumed directly as a component of alcoholic beverages. As another example, an alcohol-based solvent may improve the processed product attributes of some feedstocks. When applied to soybean flakes, for instance, an alcohol-based solvent may produce a meal with less “beany” flavor and less color. When applied to either soybean flakes or cottonseed meats, an alcohol-based solvent may alter protein solubility and lower antinutritional factor content. The alcohol-based solvent may produce an oil with lower wax and phosphatide content.

One embodiment is directed to a method that includes conveying an oleaginous material to be processed in a conveyance direction through an extractor and conveying a solvent comprising alcohol in a countercurrent direction from the conveyance direction through the extractor, thereby generating an extracted material stream and a miscella stream; cooling the miscella stream to form a cooled miscella stream comprising a solvent-rich phase, an oil-rich phase, and a solid phase comprising entrained solvent and oil; performing a first separation on the cooled miscella stream to separate either the solvent-rich phase from a remainder of the cooled miscella stream comprising the oil-rich phase and the solid phase or the oil-rich phase from the remainder of the cooled miscella stream comprising the solvent-rich phase and the solid phase; and performing a second separation on the remainder of the cooled miscella stream to separate either the oil-rich phase from the solid phase comprising entrained solvent and oil or the solvent-rich phase from the solid phase comprising entrained solvent and oil.

Embodiment 2 depends from embodiment 1 and provides that performing the first separation comprises decanting the cooled miscella stream, and performing the second separation comprises decanting the remainder of the cooled miscella stream.

Embodiment 3 depends from embodiment 1 and provides that performing the first separation on the cooled miscella stream comprises separating the solvent-rich phase from the remainder of the cooled miscella stream comprising the oil-rich phase and the solid phase comprising entrained solvent and oil, and further comprises, after performing the first separation and prior to performing the second separation, introducing water into the remainder of the cooled miscella stream to promote further phase separation of solvent and oil in the remainder of the cooled miscella stream, wherein performing the second separation on the remainder of the cooled miscella stream comprises separating the oil-rich phase from a second remainder of the cooled miscella stream.

Embodiment 4 depends from embodiment 1 and provides that performing the first separation on the cooled miscella stream comprises separating the oil-rich phase from the remainder of the cooled miscella stream comprising the solvent-rich phase and the solid phase comprising entrained solvent and oil, and further comprises, after performing the first separation and prior to performing the second separation, introducing water into the remainder of the cooled miscella stream to promote further phase separation of solvent and oil in the remainder of the cooled miscella stream, wherein performing the second separation on the remainder of the cooled miscella stream comprises separating the solvent-rich phase from a second remainder of the cooled miscella stream.

Embodiment 5 depends from embodiment 1 and provides that the method further comprises, after performing the first separation and prior to performing the second separation, introducing water into the combined stream to promote further phase separation.

Embodiment 6 depends from embodiment 1 and provides that the method further comprises receiving the oil-rich phase separated from the cooled miscella stream and/or separated from the remainder of the cooled miscella stream and performing a thermal separation on the oil-rich phase to thermally separate residual solvent from oil in the oil-rich phase, thereby forming a thermally separated solvent stream and an oil stream.

Embodiment 7 depends from embodiment 6 and provides that performing the thermal separation on the oil-rich phase comprises heating the oil-rich phase in an evaporator and/or distillation column.

Embodiment 8 depends from embodiment 6 and provides that the method further comprises recycling the thermally separated solvent stream back to the extractor and introducing the thermally separated solvent stream into the extractor.

Embodiment 9 depends from embodiment 1 and provides that cooling the miscella stream comprises cooling the miscella stream to a temperature less than 50 degrees Celsius, such as less than 40 degrees Celsius, or less than 30 degrees Celsius.

Embodiment 10 depends from embodiment 1 and provides that the miscella discharges from the extractor at a temperature greater than 50 degrees Celsius, such as greater than 60 degrees Celsius, or greater than 65 degrees Celsius. Embodiment 11 depends from embodiment 1 and provides that the alcohol comprises ethanol.

Embodiment 12 depends from embodiment 11 and provides that the solvent comprises greater than 90 weight percent ethanol and less than 10 weight percent water, such as greater than 95 weight percent ethanol and less than 5 weight percent water, or greater than 98 weight percent ethanol and less than 5 weight percent water.

Embodiment 13 depends from embodiment 1 and provides that the oleaginous material is soy.

Embodiment 14 depends from embodiment 1 and provides that the extractor is a percolation extractor.

Another embodiment 15 is directed to a method that includes conveying an oleaginous material to be processed in a conveyance direction through an extractor and conveying a solvent comprising alcohol in a countercurrent direction from the conveyance direction through the extractor, thereby generating an extracted material stream and a miscella stream; cooling the miscella stream to form a cooled miscella stream and delivering the cooled miscella stream to a density separation device; within the density separation device, separating the cooled miscella stream into a solvent-rich phase, an oil-rich phase, and a solid phase comprising entrained solvent and oil; and extracting three separate streams from the density separation device comprising a first stream of the solvent-rich phase, a second stream of the oil-rich phase, and a third stream of the solid phase comprising entrained solvent and oil.

Embodiment 16 depends from embodiment 15 and provides that the density separation device is a gravity separation vessel.

Embodiment 17 depends from embodiment 16 and provides that the gravity separation vessel is a decanter.

Embodiment 18 depends from embodiment 15 and provides that the method further comprises, after cooling the miscella stream and prior to delivering the cooled miscella stream to the density separation device, introducing water into the cooled miscella stream.

Embodiment 19 depends from embodiment 15 and provides that the method further comprises recycling the first stream of the solvent-rich phase back to the extractor.

Embodiment 20 depends from embodiment 15 and provides that the method further comprises performing a thermal separation on the second stream of the oil-rich phase to thermally separate residual solvent from oil in the oil-rich phase, thereby forming a thermally separated solvent stream and an oil stream.

Embodiment 21 depends from embodiment 15 and provides that the method further comprises performing a thermal separation on the third stream of the solid phase comprising entrained solvent and oil.

Embodiment 22 depends from embodiment 21 and provides that performing the thermal separation on the third stream of the solid phase comprising entrained solvent and oil comprises performing a first thermal separation on the third stream to thermally separate solvent from a remainder of the third stream, thereby forming a first thermally separated residual stream comprising the solid phase, and performing a second thermal separation on the first thermally separated residual stream to thermally separate solvent from the first thermally separated residual stream, thereby forming a second thermally separated residual stream comprising the solid phase.

Embodiment 23 depends from embodiment 22 and provides that performing the first thermal separation comprises performing the first thermal separation with a first evaporator, and performing the second thermal separation comprises performing the second thermal separation with a second evaporator that is more resistant to fouling than the first evaporator and/or a stripping column with direct steam injection.

Embodiment 24 depends from embodiment 23 and provides that the first evaporator is selected from the group consisting of a falling film evaporator, a forced recirculation evaporator, a rising film evaporator, and combinations thereof, and that the second evaporator is selected from the group consisting of a forced recirculation evaporator, a thin film evaporator, and combinations thereof.

Embodiment 25 depends from embodiment 22 and provides that the method further comprises introducing water into the second thermally separated residual stream to promote separation of the solid phase from solvent, separating the solid phase from the solvent in a degumming phase, and drying the solid phase to form a dried gums stream.

Embodiment 26 is directed to a method that includes conveying an oleaginous material to be processed in a conveyance direction through an extractor and conveying a solvent comprising alcohol in a countercurrent direction from the conveyance direction through the extractor, thereby generating an extracted material stream and a miscella stream; cooling the miscella stream to form a cooled miscella stream comprising a solvent-rich phase, an oil-rich phase, and a solid phase comprising entrained solvent and oil; performing a first separation on the cooled miscella stream to separate a portion of the solvent-rich phase from a first remainder of the cooled miscella stream, the first remainder of the cooled miscella stream comprising the solid phase; performing a second separation on the first remainder of the cooled miscella stream to separate a portion of the oil-rich phase from a second remainder of the cooled miscella stream, the second remainder of the cooled miscella stream comprising the solid phase; performing a first thermal separation on the second remainder of the cooled miscella stream including the solid phase to thermally separate solvent from the second remainder of the cooled miscella stream, thereby forming a first thermally separated residual stream comprising the solid phase; and performing a second thermal separation on the first thermally separated residual stream to thermally separate solvent from the first thermally separated residual stream, thereby forming a second thermally separated residual stream comprising the solid phase.

Embodiment 27 depends from embodiment 26 and provides that performing the first thermal separation comprises performing the first thermal separation with a first evaporator, and performing the second thermal separation comprises performing the second thermal separation with a second evaporator that is more resistant to fouling than the first evaporator and/or a stripping column with direct steam injection.

Embodiment 28 depends from embodiment 27 and provides that the first evaporator is selected from the group consisting of a falling film evaporator, a forced recirculation evaporator, a rising film evaporator, and combinations thereof, and that the second evaporator is selected from the group consisting of a forced recirculation evaporator, a thin film evaporator, and combinations thereof.

Embodiment 29 depends from embodiment 26 and provides that performing the first separation comprises decanting the cooled miscella stream, and performing the second separation comprises decanting the first remainder of the cooled miscella stream.

Embodiment 30 depends from embodiment 29 and provides that decanting the cooled miscella stream comprises drawing a set ratio of the solvent-rich phase from the cooled miscella stream, wherein a volume of the portion of the solvent-rich phase separated from the cooled miscella stream divided by a total volume of the cooled miscella stream decanted is within a range from 5% to 80%.

Embodiment 31 depends from embodiment 29 and provides that decanting the first remainder of the cooled miscella stream comprises drawing a set ratio of the oil-rich phase from the first remainder of the cooled miscella stream, wherein a volume of the portion of the oil-rich phase separated from the first remainder of the cooled miscella stream divided by a total volume of the first remainder of the cooled miscella stream decanted is within a range from 55% to 75%.

Embodiment 32 depends from embodiment 26 and provides that the method further comprises introducing water into the second thermally separated residual stream to promote separation of the solid phase from solvent, separating the solid phase from the solvent in a degumming phase, and drying the solid phase to form a dried gums stream.

Embodiment 33 depends from embodiment 26 and provides that the method further comprises introducing water into the first remainder of the cooled miscella stream between the first separation and the second separation to promote further solvent-oil phase separation and/or introducing water into the second thermally separated residual stream to promote further solvent-oil phase separation.

Embodiment 34 depends from embodiment 26 and provides that the method further comprises performing a third thermal separation on the portion of the oil-rich phase separated by the second separation, the third thermal separation vaporizing solvent from the portion of the oil-rich phase to form a concentrated oil-rich phase.

Embodiment 35 depends from embodiment 34 and provides that performing the third thermal separation comprises performing the third thermal separation with an evaporator and/or stripping column.

Embodiment 36 depends from embodiment 34 and provides that performing the third thermal separation comprises performing the third thermal separation with an evaporator and subsequently stripping residual solvent from the concentrated oil-rich phase with a stripping column.

Various examples have been described. These and other examples are within the scope of the following claims.

1. A method comprising:
conveying an oleaginous material to be processed in a conveyance direction through an extractor and conveying a solvent comprising alcohol in a countercurrent direction from the conveyance direction through the extractor, thereby generating an extracted material stream and a miscella stream;
cooling the miscella stream to form a cooled miscella stream comprising a solvent-rich phase, an oil-rich phase, and a solid phase comprising entrained solvent and oil;
performing a first separation on the cooled miscella stream to separate (i) the solvent-rich phase from a remainder of the cooled miscella stream comprising the oil-rich phase and the solid phase or (ii) the oil-rich phase from the remainder of the cooled miscella stream comprising the solvent-rich phase and the solid phase; and
performing a second separation on the remainder of the cooled miscella stream comprising to separate (i) the oil-rich phase from the solid phase comprising entrained solvent and oil or (ii) the solvent-rich phase from the solid phase comprising entrained solvent and oil.

2. The method of claim 1, wherein:
performing the first separation comprises decanting the cooled miscella stream; and
performing the second separation comprises decanting the remainder of the cooled miscella stream.

3. The method of claim 1:
wherein performing the first separation on the cooled miscella stream comprises separating the solvent-rich phase from the remainder of the cooled miscella stream comprising the oil-rich phase and the solid phase comprising entrained solvent and oil; and
further comprising, after performing the first separation and prior to performing the second separation introducing water into the remainder of the cooled miscella stream to promote further phase separation of solvent and oil in the remainder of the cooled miscella stream;
wherein performing the second separation on the remainder of the cooled miscella stream comprises separating the oil-rich phase from a second remainder of the cooled miscella stream.

4. The method of claim 1:
wherein performing the first separation on the cooled miscella stream comprises separating the oil-rich phase from the remainder of the cooled miscella stream comprising the solvent-rich phase and the solid phase comprising entrained solvent and oil; and
further comprising, after performing the first separation and prior to performing the second separation, introducing water into the remainder of the cooled miscella stream to promote further phase separation of solvent and oil in the remainder of the cooled miscella stream;
wherein performing the second separation on the remainder of the cooled miscella comprises separating the solvent-rich phase from a second remainder of the cooled miscella stream.

5. The method of claim 1, further comprising, after performing the first separation and prior to performing the second separation introducing water into the combined stream to promote further phase separation.

6. The method of claim 1, further comprising receiving the oil-rich phase separated from the cooled miscella stream and/or separated from the remainder of the cooled miscella and performing a thermal separation on the oil-rich phase to thermally separate residual solvent from oil in the oil-rich phase, thereby forming a thermally separated solvent stream and an oil stream.

7. A method comprising:
conveying an oleaginous material to be processed in a conveyance direction through an extractor and conveying a solvent comprising alcohol in a countercurrent direction from the conveyance direction through the extractor, thereby generating an extracted material stream and a miscella stream;
cooling the miscella stream to form a cooled miscella stream and delivering the cooled miscella stream to a density separation device;
within the density separation device, separating the cooled miscella stream into a solvent-rich phase, an oil-rich phase, and a solid phase comprising entrained solvent and oil; and
extracting three separate streams from the density separation device: a first stream of the solvent-rich phase, a second stream of the oil-rich phase, and a third stream of the solid phase comprising entrained solvent and oil.

8. The method of claim 7, wherein the density separation device is a gravity separation vessel.

9. The method of claim 7, further comprising performing a thermal separation on the second stream of the oil-rich phase to thermally separate residual solvent from oil in the oil-rich phase, thereby forming a thermally separated solvent stream and an oil stream.

10. The method of claim 7, further comprising performing a thermal separation on the third stream of the solid phase comprising entrained solvent and oil.

11. The method of claim 10, wherein performing the thermal separation on the third stream of the solid phase comprising entrained solvent and oil comprises:
performing a first thermal separation on the third stream to thermally separate solvent from a remainder of the third stream, thereby forming a first thermally separated residual stream comprising the solid phase; and
performing a second thermal separation on the first thermally separated residual stream to thermally separate solvent from the first thermally separated residual stream, thereby forming a second thermally separated residual stream comprising the solid phase.

12. The method of claim 11, wherein:
performing the first thermal separation comprises performing the first thermal separation with a first evaporator; and
performing the second thermal separation comprises performing the second thermal separation with a second evaporator that is more resistant to fouling than the first evaporator and/or a stripping column with direct steam injection.

13. A method comprising:
conveying an oleaginous material to be processed in a conveyance direction through an extractor and conveying a solvent comprising alcohol in a countercurrent direction from the conveyance direction through the extractor, thereby generating an extracted material stream and a miscella stream;
cooling the miscella stream to form a cooled miscella stream comprising a solvent-rich phase, an oil-rich phase, and a solid phase comprising entrained solvent and oil;
performing a first separation on the cooled miscella stream to separate a portion of the solvent-rich phase from a first remainder of the cooled miscella stream, the first remainder of the cooled miscella stream comprising the solid phase;
performing a second separation on the first remainder of the cooled miscella stream to separate a portion of the oil-rich phase from a second remainder of the cooled miscella stream, the second remainder of the cooled miscella stream comprising the solid phase;
performing a first thermal separation on the second remainder of the cooled miscella stream including the solid phase to thermally separate solvent from the second remainder of the cooled miscella stream, thereby forming a first thermally separated residual stream comprising the solid phase; and
performing a second thermal separation on the first thermally separated residual stream to thermally separate solvent from the first thermally separated residual stream, thereby forming a second thermally separated residual stream comprising the solid phase.

14. The method of claim 13, wherein:
performing the first thermal separation comprises performing the first thermal separation with a first evaporator; and
performing the second thermal separation comprises performing the second thermal separation with a second evaporator that is more resistant to fouling than the first evaporator and/or a stripping column with direct steam injection.

15. The method of claim 14, wherein:
the first evaporator is selected from the group consisting of a falling film evaporator, a forced recirculation evaporator, a rising film evaporator, and combinations thereof; and
the second evaporator is selected from the group consisting of a forced recirculation evaporator, a thin film evaporator, and combinations thereof.

16. The method of claim 14, wherein:
performing the first separation comprises decanting the cooled miscella stream; and
performing the second separation comprises decanting the first remainder of the cooled miscella stream.

17. The method of claim 16, wherein decanting the cooled miscella stream comprises drawing a set ratio of the solvent-rich phase from the cooled miscella stream, wherein a volume of the portion of the solvent-rich phase separated from the cooled miscella stream divided by a total volume of the cooled miscella stream decanted is within a range from 5% to 80%.

18. The method of claim 16, wherein decanting the first remainder of the cooled miscella stream comprises drawing a set ratio of the oil-rich phase from the first reminder of the cooled miscella stream, wherein a volume of the portion of the oil-rich phase separated from the first reminder of the cooled miscella stream divided by a total volume of the first remainder of the cooled miscella stream decanted is within a range from 55% to 75%.

19. The method of claim 13, further comprising:
introducing water into the second thermally separated residual stream to promote separation the solid phase from solvent;
separating the solid phase from the solvent in a degumming phase; and
drying the solid phase to form a dried gums stream.

20. The method of claim 13, further comprising:
introducing water into the first remainder of the cooled miscella stream between the first separation and the second separation to promote further solvent-oil phase separation; and/or
introducing water into the second thermally separated residual stream to promote further solvent-oil phase separation.

21. The method of claim 13, further comprising performing a third thermal separation on the portion of the oil-rich phase separated by the second separation, the third thermal separation vaporizing solvent from the portion of the oil-rich phase to form a concentrated oil-rich phase.

22. The method of claim 21:
wherein performing the third thermal separation comprises performing the third thermal separation with an evaporator; and
subsequently stripping residual solvent from the concentrated oil-rich phase with a stripping column.
